(19) United States
(12) Patent Application Publication
(10) Pub. No.: US 2025/0315685 A1
(43) Pub. Date: Oct. 9, 2025

(54) METHOD, COMPUTER PROGRAM, AND COMPUTING DEVICE FOR PERFORMING DEEP REINFORCEMENT LEARNING BASED ON Q-FUNCTION

(71) Applicant: SEOUL NATIONAL UNIVERSITY R&DB FOUNDATION, Seoul (KR)

(72) Inventors: Lee JUNGWOO, Seoul (KR); Han SEUNGYUB, Seoul (KR); Lee DOHYEOK, Seoul (KR); Cho TAEHYUN, Seoul (KR)

(21) Appl. No.: 18/756,168

(22) Filed: Jun. 27, 2024

(30) Foreign Application Priority Data
Apr. 9, 2024 (KR) 10-2024-0048049

(51) Int. Cl. G06N 3/092; G06F 17/18

(52) U.S. Cl. CPC G06N 3/092; G06F 17/18

(57) ABSTRACT

According to an aspect of the present invention, there is provided a method of performing deep reinforcement learning based on a Q-function ensemble, which is performed by a computing device including at least one processor. The method includes: generating a symmetric matrix based on individual values respectively output from a plurality of individual Q-function models constituting a Q-function ensemble; comparing the distribution of the eigenvalues of the symmetric matrix with a reference distribution; defining a regularization loss function based on the results of the comparison; and training the plurality of individual Q-function models based on the defined regularization loss function.

### CROSS-REFERENCE TO RELATED APPLICATION

This application claims the benefit of Korean Patent Application No. 10-2024-0048049 filed on Apr. 9, 2024, which is hereby incorporated by reference herein in its entirety.

### DESCRIPTION OF GOVERNMENT-FUNDED RESEARCH AND DEVELOPMENT

The present disclosure is made with the support of the Ministry of Science and ICT, Republic of Korea, under the following project identifications and numbers:

Project Identification No. 1711189307 and Project No. 2021R1A2C2014504, which was conducted in the task named “Research on Reinforcement Learning for Stepwise Task Execution Based on Automatic Natural Language Question Generation” in the research project named “Individual Basic Research (MSIT) “, by Seoul National University, under the research management of the National Research Foundation of Korea, from Mar. 1, 2021, to Feb. 29, 2024.

Project Identification No. 1711193316 and Project No. 2021-0-00106-003, which was conducted in the task named “Development of Accelerator Optimization-Based Artificial Neural Network Automatic Generation Technology and Open Service Platform” in the research project named “SW Computing Industry Original Technology Development”, by the Research & Foundation of Seoul National University, under the Business research management the of Institute of Information & Communications Technology Planning & Evaluation (IITP), from Apr. 1, 2021, to Dec. 31, 2024.

Project Identification No. 1711152550 and Project No. 2021-0-01059-002, which was conducted in the task named “Solving Batch Learning Optimization Problems for Quantum Deep Learning” in the research project named “SW Computing Industry Original Technology Development”, by the Research & Business Foundation of Seoul National University, under the research management of the Institute of Information & Communications Technology Planning & Evaluation (IITP), from Apr. 1, 2021, to Dec. 31, 2024.

### BACKGROUND

### 1. Technical Field

The present disclosure relates to performing deep reinforcement learning using artificial neural networks, and more particularly to a method, computer program, and computing device for performing deep reinforcement learning based on a Q-function ensemble.

### 2. Description of the Related Art

Reinforcement learning techniques using artificial neural networks are referred to as deep reinforcement learning. Deep reinforcement learning aims to achieve optimal time-series behavior by learning an optimal behavior policy network through new training data. For this reason, deep reinforcement learning is used to solve time-series decision-making problems such as robot manipulation and game artificial intelligence (AI), e.g., AlphaGo.

An agent in deep reinforcement learning is trained on a Q-function that predicts the final cumulative reward (value) that can be obtained based on random states and actions. Through this, the agent may predict the action that will lead to an optimal result in a current state.

Generally, deep reinforcement learning predicts an expected value for a given action in a current state by using a single Q-function. In this case, the Q-function is also called a value function or a value neural network.

However, in real environments, problem of the overestimating a reward value for unobserved state and action data may occur. As a result, there may be cases where a non-optimal action is mistakenly decided to be optimal. This phenomenon may be particularly problematic in off-policy reinforcement learning or offline reinforcement learning.

Therefore, various methods of improving the performance of deep reinforcement learning by reducing overestimation bias for out-of-distribution data are being researched.

Traditional methods of reducing the overestimation bias of the Q-function include a regularization technique and a Q-function ensemble technique. The regularization technique uses a loss function to reduce the values of state inputs that may be overestimated. However, there is a risk in that reward value assessment will be conservative. The Q-function ensemble technique is a method of independently training a plurality of artificial neural networks initialized in various manners and determining an optimal action by selecting the lowest one of the evaluation values of individual Q-functions that constitute an ensemble. According to this method, the largest one of such calculated minimum values is designated as an optimal action in a current state.

However, the Q-function ensemble technique may also cause the overestimation bias problem of the conventional single Q-function technique because, although independently initialized individual Q-functions are trained based on the same training data, the output values of individual Q-function neural networks are not sufficiently independent of each other.

### SUMMARY

The present disclosure has been conceived in response to the above-described background technology, and an object of the present disclosure is to provide a method of performing deep reinforcement learning by quantitatively measuring and controlling the independence between individual Q-functions to minimize overestimation bias that may occur in a Q-function ensemble technique.

However, the objects to be accomplished by the present disclosure are not limited to the object mentioned above, and other objects not mentioned may be clearly understood based on the following description.

According to an aspect of the present invention, there is provided a method of performing deep reinforcement learning based on a Q-function ensemble, which is performed by a computing device including at least one processor. The method includes: generating a symmetric matrix based on individual values respectively output from a plurality of individual Q-function models constituting a Q-function ensemble; comparing the distribution of the eigenvalues of the symmetric matrix with a reference distribution; defining a regularization loss function based on the results of the comparison; and training the plurality of individual Q-function models based on the defined regularization loss function.

Generating the symmetric matrix may include generating the symmetric matrix by shuffling the order of the individual values and then filling the elements of the upper triangular region of the symmetric matrix with the individual values.

The size of the symmetric matrix may be determined to be a maximum size required to fill the elements of the triangular area with the individual values.

Defining the regularization loss function may include: calculating a pulse train probability distribution based on the eigenvalues of the symmetric matrix; and defining the regularization loss function based on the pulse train probability distribution and the reference distribution.

The reference distribution may be a soft Wigner's semicircle distribution.

The regularization loss function may be represented by the following equation:

$${L}_{spqr} = β \frac{1}{\vert B \vert} {\sum }_{i} {\sum }_{j} {p}_{esd} ( {λ}_{i} ) log \frac{{p}_{esd} ( {λ}_{i} )}{{p}_{wigner} ( {λ}_{j} )}$$

where:
L_{spqr} is the regularization loss function;
β is the coefficient of the regularization loss function;
p_{esd}(λᵢ) is the pulse train probability distribution;
p_{wigner}(λⱼ) is the soft Wigner's semicircle distribution; and
   |B| is the size of a batch sampled in a buffer.

Training the plurality of individual Q-function models may include determining the degree of independence between the plurality of individual Q-function models by adjusting the coefficient of the regularization loss function.

As the coefficient of the regularization loss function increases, the degree of independence between the plurality of individual Q-function models may also increase.

According to another aspect of the present invention, there is provided a computer program stored in a computer-readable storage medium. The computer program performs operations of performing deep reinforcement learning based on a Q-function ensemble when executed on at least one processor, and the operations include operations of: generating a symmetric matrix based on individual values respectively output from a plurality of individual Q-function models constituting a Q-function ensemble; comparing the distribution of the eigenvalues of the symmetric matrix with a reference distribution; defining a regularization loss function based on the results of the comparison; and training the plurality of individual Q-function models based on the defined regularization loss function.

According to still another aspect of the present invention, there is provided a computing device for performing deep reinforcement learning based on a Q-function ensemble. The computing device includes a processor including at least one core, and memory including program codes that are executable on the processor, and the processor generates a symmetric matrix based on individual values respectively output from a plurality of individual Q-function models constituting a Q-function ensemble, compares the distribution of the eigenvalues of the symmetric matrix with a reference distribution, defines a regularization loss function based on the results of the comparison, and trains the plurality of individual Q-function models based on the defined regularization loss function.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram of a computing device according to an embodiment of the present disclosure;

FIG. 2 is a flowchart showing a method of performing deep reinforcement learning according to an embodiment of the present disclosure;

FIGS. 3 and 4 are exemplary diagrams showing algorithms of a method of performing deep reinforcement learning according to an embodiment of the present disclosure;

FIG. 5 is an exemplary diagram showing a method of teaching the independence between individual Q-functions according to an embodiment of the present disclosure;

FIG. 6 is an exemplary diagram showing a method of generating a symmetric matrix according to an embodiment of the present disclosure;

FIG. 7 is a table showing the performance of a method of performing deep reinforcement learning according an embodiment of the present disclosure;

FIG. 8 is a graph showing the performance of a method of performing deep reinforcement learning according to an embodiment of the present disclosure; and

FIG. 9 is an exemplary diagram showing a method of evaluating the independence between individual Q-functions according to an embodiment of the present disclosure.

### DETAILED DESCRIPTION

Embodiments of the present disclosure will be described in detail below with reference to the accompanying drawings so that those having ordinary skill in the art of the present disclosure (hereinafter referred to as those skilled in the art) can implement the present disclosure. The embodiments presented in the present disclosure are provided to enable those skilled in the art to use or practice the content of the present disclosure. Accordingly, various modifications to embodiments of the present disclosure will be apparent to those skilled in the art. That is, the present disclosure may be implemented in various different forms and is not limited to the following embodiments.

The same or similar reference numerals denote the same or similar components throughout the specification of the present disclosure. Additionally, in order to clearly describe the present disclosure, reference numerals for parts that are not related to the description of the present disclosure may be omitted in the drawings.

The term “or” used herein is intended not to mean an exclusive “or” but to mean an inclusive “or.” That is, unless otherwise specified herein or the meaning is not clear from the context, the clause “X uses A or B” should be understood to mean one of the natural inclusive substitutions. For example, unless otherwise specified herein or the meaning is not clear from the context, the clause “X uses A or B” may be interpreted as any one of a case where X uses A, a case where X uses B, and a case where X uses both A and B.

The term “at least one of A and B” used herein should be interpreted to refer to all of A, B, and a combination of A and B.

The term “and/or” used herein should be understood to refer to and include all possible combinations of one or more of listed related concepts.

The terms “include” and/or “including” used herein should be understood to mean that specific features and/or components are present. However, the terms “include” and/or “including” should be understood as not excluding the presence or addition of one or more other features, one or more other components, and/or combinations thereof.

Unless otherwise specified herein or unless the context clearly indicates a singular form, the singular form should generally be construed to include “one or more.”

The term “N-th (N is a natural number)” used herein can be understood as an expression used to distinguish the components of the present disclosure according to a predetermined criterion such as a functional perspective, a structural perspective, or the convenience of description. For example, in the present disclosure, components performing different functional roles may be distinguished as a first component or a second component. However, components that are substantially the same within the technical spirit of the present disclosure but should be distinguished for the convenience of description may also be distinguished as a first component or a second component.

Meanwhile, the term “module” or “unit” used herein may be understood as a term referring to an independent functional unit processing computing resources, such as a computer-related entity, firmware, software or part thereof, hardware or part thereof, or a combination of software and hardware. In this case, the “module” or “unit” may be a unit composed of a single component, or may be a unit expressed as a combination or set of multiple components. For example, in the narrow sense, the term “module” or “unit” may refer to a hardware component or set of components of a computing device, an application program performing a specific function of software, a procedure implemented through the execution of software, a set of instructions for the execution of a program, or the like. Additionally, in the broad sense, the term “module” or “unit” may refer to a computing device itself constituting part of a system, an application running on the computing device, or the like. However, the above-described concepts are only examples, and the concept of “module” or “unit” may be defined in various manners within a range understandable to those skilled in the art based on the content of the present disclosure.

The term “model” used herein may be understood as a system implemented using mathematical concepts and language to solve a specific problem, a set of software units intended to solve a specific problem, or an abstract model for a process intended to solve a specific problem. For example, a neural network “model” may refer to an overall system implemented as a neural network that is provided with problem-solving capabilities through training. In this case, the neural network may be provided with problem-solving capabilities by optimizing parameters connecting nodes or neurons through training. The neural network “model” may include a single neural network, or a neural network set in which multiple neural networks are combined together.

The foregoing descriptions of the terms are intended to help to understand the present disclosure. Accordingly, it should be noted that unless the above-described terms are explicitly described as limiting the content of the present disclosure, the terms in the content of the present disclosure are not used in the sense of limiting the technical spirit of the present disclosure.

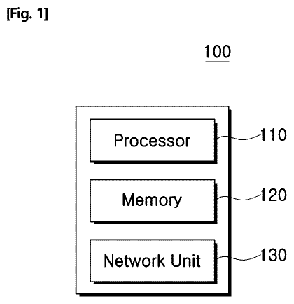

FIG. 1 is a block diagram of a computing device according to an embodiment of the present disclosure.

A computing device 100 according to an embodiment of the present disclosure may be a hardware device or part of a hardware device that performs the comprehensive processing and calculation of data, or may be a software-based computing environment that is connected to a communication network. For example, the computing device 100 may be a server that performs an intensive data processing function and shares resources, or may be a client that shares resources through interaction with a server. Furthermore, the computing device 100 may be a cloud system in which a plurality of servers and clients interact with each other and comprehensively process data. Since the above descriptions are only examples related to the type of computing device 100, the type of computing device 100 may be configured in various manners within a range understandable to those skilled in the art based on the content of the present disclosure.

Referring to FIG. 1, the computing device 100 according to an embodiment of the present disclosure may include a processor 110, memory 120, and a network unit 130. However, FIG. 1 shows only an example, and the computing device 100 may include other components for implementing a computing only some of the components environment. Furthermore, disclosed above may be included in the computing device 100.

The processor 110 according to an embodiment of the present disclosure may be understood as a configuration unit including hardware and/or software for performing computing operation. For example, the processor 110 may read a computer program and perform data processing for machine learning. The processor 110 may process computational processes such as the processing of input data for machine learning, the extraction of features machine learning, and the calculation of errors based on backpropagation. The processor 110 for performing such data processing may include a central processing unit (CPU), a general purpose graphics processing unit (GPGPU), a tensor processing unit (TPU), an application specific integrated circuit (ASIC), or a field programmable gate array (FPGA). Since the types of processor 110 described above are only examples, the type of processor 110 may be configured in various manners within a range understandable to those skilled in the art based on the content of the present disclosure.

The term “deep reinforcement learning” used herein may basically refer to actor-critic deep reinforcement learning (ACDRL).

The environment in which reinforcement learning is performed includes a Markov decision process, and individual components thereof may be defined as follows:
S: state space
A: action space
P: S×A→S: transition probability
r: S→R: reward function
γ: discount factor

In reinforcement learning, an actor plays the role of deciding an action that will be taken in a given current state, and an artificial neural network that makes the decision is called a policy network. The expected cumulative future reward that an action decided in a given state will receive from now to the future is referred to as a value function or a Q-function, and a critic calculates and updates it.

In this case, the Q-function tends to overestimate the cumulative future reward. To reduce this, ensemble reinforcement learning may be employed. In the ensemble reinforcement learning, a plurality of Q-functions may be introduced and initialized to different values, and then expected cumulative future reward may be learned using the same training data.

In the present disclosure, an ensemble reinforcement learning technique is called a Q-function ensemble, and each of the plurality of Q-functions used is called an individual Q-function.

In the Q-function ensemble, a Q-function having the smallest value out of individual Q-functions having expected cumulative rewards for a given state and action may be used as the expected cumulative reward. In this case, the smallest value for each action may be considered to be the expected cumulative reward. Then, an actor policy network may be trained to select an action having the highest one of the above values. The goal of training is to take an optimal action while preventing the overestimation of each action.

In this case, the individual Q-functions are trained in a direction in which they have a high correlation with each other, and thus, may not provide independent expected reward values. Accordingly, in the present disclosure, a regularization loss function may be used to ensure the independence between the individual Q-functions, as will be described later.

That is, the processor 110 may define a regularization loss function that can reflect and adjust the independence between the individual Q-functions, and may train a plurality of individual Q-function models by applying the regularization loss function to the plurality of individual Q-function models that constitute the Q-function ensemble. Furthermore, the processor 110 may determine the degree of independence between the plurality of individual Q-function models by adjusting the coefficient of the regularization loss function.

The memory 120 according to an embodiment of the present disclosure may be understood as a configuration unit including hardware and/or software for storing and managing data that is processed in the computing device 100. That is, the memory 120 may store any type of data generated or determined by the processor 110 and any type of data received by the network unit 130. For example, the memory 120 may include at least one type of storage medium of a flash memory type, hard disk type, multimedia card micro type, and card type memory, random access memory (RAM), static random access memory (SRAM), read-only memory (ROM), electrically erasable programmable read-only memory (EEPROM), programmable read-only memory (PROM), magnetic memory, a magnetic disk, and an optical disk. Furthermore, the memory 120 may include a database system that controls and manages data in a predetermined system. Since the types of memory 120 described above are only examples, the type of memory 120 may be configured in various manners within a range understandable to those skilled in the art based on the content of the present disclosure.

The memory 120 according to the present disclosure may store training data required to perform deep reinforcement learning. Furthermore, the memory 120 may store data on states, actions, and rewards obtained while the policy network takes actions. This data may be stored in a replay buffer. More specifically, the memory 120 may store obtained reward and information about a subsequent state in the replay buffer after an action has been taken in a given environmental state using the policy network.

The network unit 130 according to an embodiment of the present disclosure may be understood as a configuration unit that transmits and receives data through any type of known wired/wireless communication system. For example, the network unit 130 may perform data transmission and reception using a wired/wireless communication system such as a local area network (LAN), a wideband code division multiple access (WCDMA) network, a long term evolution (LTE) network, the wireless broadband Internet (WiBro), a 5th generation mobile communication (5G) network, a ultra wide-band wireless communication network, a ZigBee network, a radio frequency (RF) communication network, a wireless LAN, a wireless fidelity network, a near field communication (NFC) network, or a Bluetooth network. Since the above-described communication systems are only examples, the wired/wireless communication system for the data transmission and reception of the network unit 130 may be applied in various manners other than the above-described examples.

The network unit 130 according to the present disclosure may receive training data required to perform deep reinforcement learning from the outside and may transmit data on the Q-function ensemble, on which training has been completed, to the outside.

According to the present disclosure, the loss function capable of guaranteeing the independence between the individual Q-functions may be applied without a prior assumption about the distribution of the-Q function ensemble by adopting a random matrix theory and a spike random model in a deep reinforcement learning algorithm.

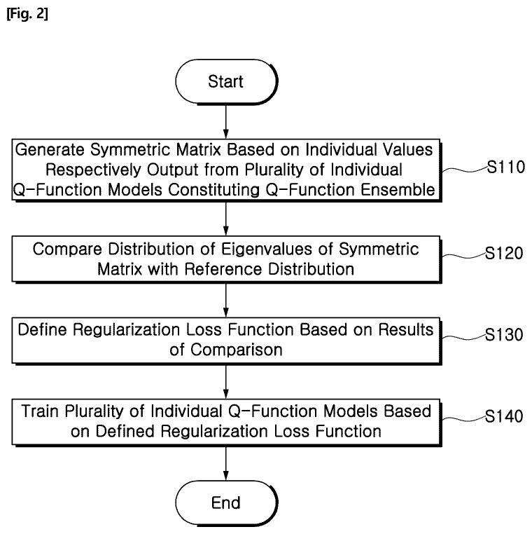

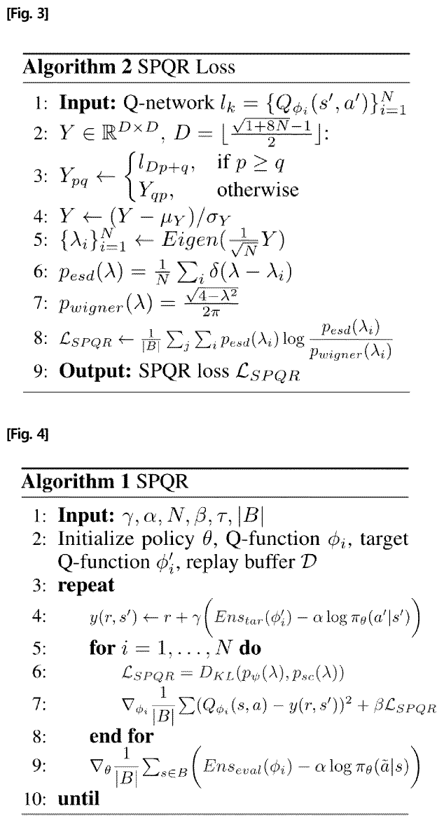

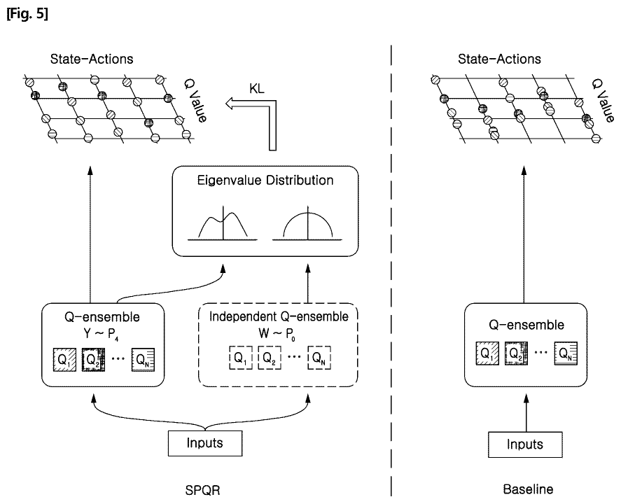

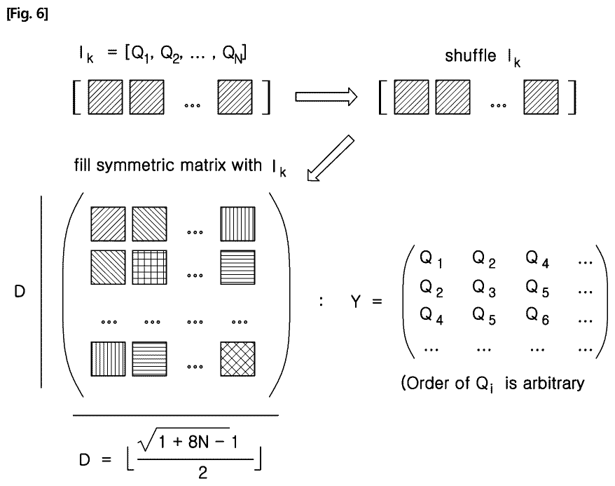

FIG. 2 is a flowchart showing a method of performing deep reinforcement learning according to an embodiment of the present disclosure, FIGS. 3 and 4 are exemplary diagrams showing algorithms of a method of performing deep reinforcement learning according to an embodiment of the present disclosure, FIG. 5 is an exemplary diagram showing a method of teaching the independence between individual Q-functions according to an embodiment of the present disclosure, and FIG. 6 is an exemplary diagram showing a method of generating a symmetric matrix according to an embodiment of the present disclosure.

Referring to FIG. 2, the computing device 100 may generate a symmetric matrix based on individual values output respectively from a plurality of individual Q-function models constituting a Q-function ensemble in step S110. In this case, the computing device 100 may shuffle the order of the individual values. Furthermore, the computing device 100 may fill the elements of the upper triangular area of the symmetric matrix with the individual values. The size of the symmetric matrix may be determined to be the maximum size required to fill the elements of the triangular area with the individual values. For example, the symmetric matrix may be a symmetric square matrix.

Meanwhile in this specification, the value may also be referred to as a Q-value.

The computing device 100 may compare the distribution of eigenvalues of the symmetric matrix with a reference distribution in step S120. In this case, the reference distribution may mean the soft Wigner's semicircle distribution.

The computing device 100 may define a regularization loss function based on the results of the comparison in step S130. In this case, the computing device 100 may calculate a pulse train probability distribution based on the eigenvalues of the symmetric matrix. The computing device 100 may define the regularization loss function based on the pulse train probability distribution and the reference distribution.

Referring to FIG. 3, the regularization loss function may be defined according to the algorithm of FIG. 3. In FIG. 3, SPQR Loss denotes the regularization loss function according to the present disclosure. Line 3 of FIG. 3 states the process of generating a random matrix, line 4 thereof states a regularization process, and line 5 thereof states the process of calculating the eigenvalues of a symmetric matrix. In this case, λᵢ denotes the eigenvalues of the symmetric matrix generated based on the values output from individual Q-functions.

Line 6 of FIG. 3 states the process of calculating a pulse train probability distribution based on the eigenvalues of the symmetric matrix. In other words, when one symmetric matrix is generated using the values respectively output from the individual Q-functions, the distribution of the eigenvalues of the symmetric matrix is identified. Line 7 thereof states the process of calculating the soft Wigner's semicircle distribution.

Line 8 of FIG. 3 states the process of finally defining the regularization loss function. As an example, the regularization loss function may reflect the difference between the distribution of the eigenvalues of the symmetric matrix and a reference distribution, e.g., the soft Wigner's semicircle distribution, therein. As an example, the Kullback-Leibler (KL) divergence between the distribution of the eigenvalues of the symmetric matrix and the soft Wigner's semicircle distribution may be calculated and used. The calculated regularization loss function may be represented by Equation 1 below:

$${L}_{spqr} = β \frac{1}{\vert B \vert} {\sum }_{i} {\sum }_{j} {p}_{esd} ( {λ}_{i} ) log \frac{{p}_{esd} ( {λ}_{i} )}{{p}_{wigner} ( {λ}_{j} )} \qquad ( 1 )$$

where Lₛₚₐᵣ is the regularization loss function, β is the coefficient of the regularization loss function, p_{esd}(λᵢ) is the pulse train probability distribution, p_{wigner}(λⱼ) is the soft Wigner's semicircle distribution, and |B| is the size of the batch sampled in the buffer.

Referring to FIG. 5, a conventional method may be represented by Baseline, and the invention proposed in the present disclosure may be represented by SPQR. A symmetric matrix generated from the values of individual Q-functions may be set to Y, and the soft Wigner's semicircle distribution may be calculated by regularizing Y to units with mean 0 and variance 1. Furthermore, the KL divergence between the actual distribution and the soft Wigner's semicircle distribution may be calculated.

Referring to FIG. 6, the values that are the outputs of the individual Q-functions may be shuffled and the symmetric matrix may be filled with these values. In this case, the size of the symmetric matrix may be determined according to an ensemble size, i.e., the number of individual Q-functions.

The computing device 100 may train the plurality of individual Q-function models based on the defined regularization loss function in step S140. In this case, the computing device 100 may determine the degree of independence between the plurality of individual Q-function models by adjusting the coefficient of the regularization loss function.

Now, referring to FIG. 4, a deep reinforcement learning algorithm to which the regularization loss function defined according to the present disclosure is applied will be described in detail. γ is the discount rate, α is the temperature parameter, N is the ensemble size, β is the coefficient of the regularization loss function, τ is polyak, |B| is the batch size, θ is the policy network, ϕᵢ is the Q-function, and ϕ′ᵢ is the target Q function. [symbol] is a replay buffer, which can store data on states, actions, and rewards obtained while the policy network performs actions.

Before the performance of the process stated in line 4 of FIG. 4, an action is taken in a given environmental state using the policy network, and obtained reward and information about a subsequent state are stored in the replay buffer.

Furthermore, a batch having a preset size in the replay buffer is sampled, and [symbol] to be learned is calculated as the target value of the Q-function in the process stated in line 4 of FIG. 4. [symbol] denotes the cumulative future reward expected under a specific policy or condition. The value of [symbol] is the target value of the algorithm, and all the individual Q-functions constituting the Q-function ensemble may be trained to approximate the value of [symbol] .

In this case, Ensₜₐᵣ(ϕ′ᵢ) denotes the smallest value of the individual Q-functions that constitute the Q-function ensemble. Furthermore, αlogπ_{θ}(a′|s′) denotes an additional entropy function.

In this case, in each of the individual Q-functions, the action that maximizes the individual Q-function is found among all possible actions in a given state, and the minimum value is selected from the maximum Q values obtained through this process.

Line 6 of FIG. 4 states the regularization loss function defined through the above description. The regularization loss function is added to the process of training the Q-function ensemble. The regularization loss function helps the individual Q-functions desirably converge to the target value of [symbol] , and serves to prevent overfitting and improve generalization performance.

In the process stated in line 7 of FIG. 4, gradient descent is applied to the individual Q-functions using N different batch samples. Through this process, all the individual Q-functions of the Q-function ensemble may be gradually adjusted to approximate the target value of [symbol] .

In the process stated in line 9 of FIG. 4, B batches are sampled, and the policy network is trained to select the action that maximizes the Q-function.

Meanwhile, the regularization loss function defined in step S130 may additionally be applied to the existing loss function that is applied to the critic network of the deep reinforcement learning algorithm.

That is, the computing device 100 according to the present disclosure proposes a computationally feasible independence regularization method for a Q-function ensemble using a spiked Wishart model.

W, which represents a Q-function ensemble completely independent of Y, i.e., a Q value learned by the Q-function learning algorithm, is introduced by applying a learning concept in the Q-function ensemble to the spiked Wishart model. If W dominates Y, Y may follow the independence assumption of the Q-function ensemble. Otherwise, there will be a high correlation with the decay of the Q value, so that no benefit can be obtained from the ensemble method.

Furthermore, there is proposed a traceable Q-function ensemble independence loss function having gain. B is the coefficient of a regularization loss function. As the value of B increases, the probability of independence becomes higher. In other words, as the coefficient of the regularization loss function increases, degree of independence between a plurality of individual Q-function models also increase.

Based on a random matrix theory and a spike random model, the loss function of the present disclosure can minimize D_{KL}(P_{ψ}(λ), p_{sc}(λ)) in the form of regularization loss in the basic learning algorithm of the Q-function ensemble. This loss function performs penalization for straying excessively far from the independent Q-function ensemble, which means stimulating the Q-function ensemble to follow [symbol] ₀.

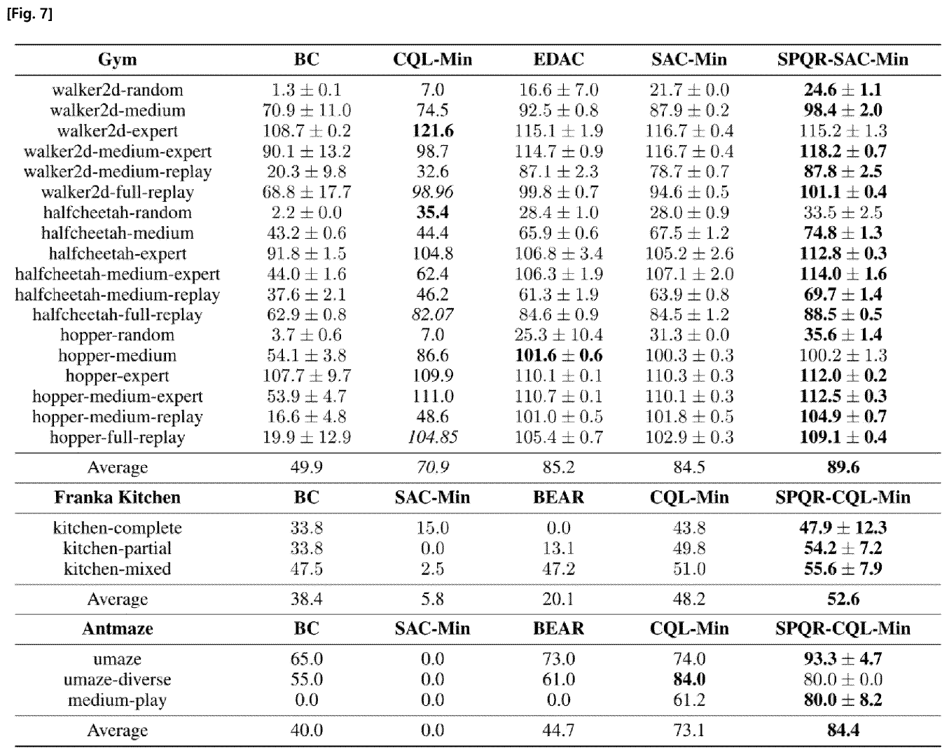

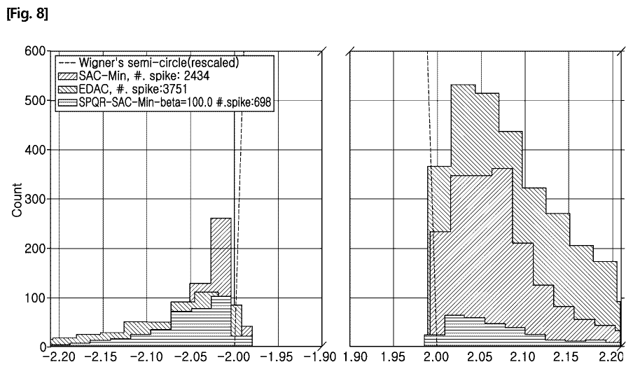

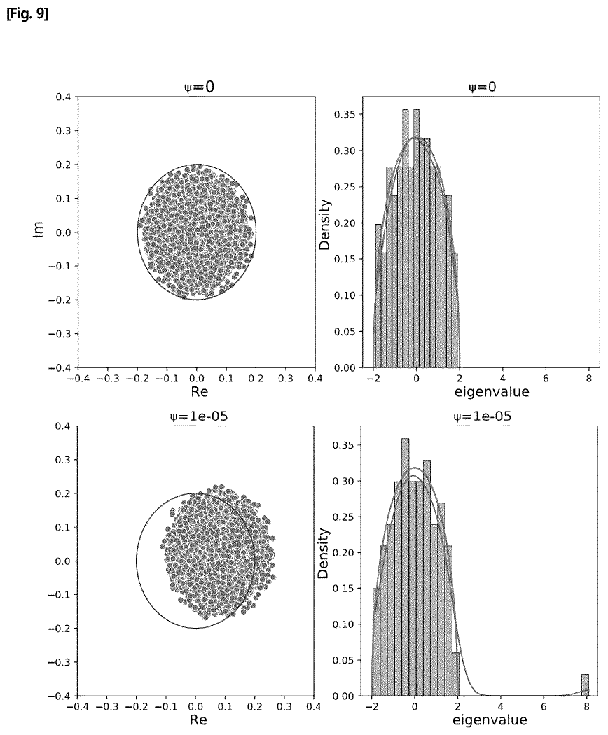

FIG. 7 is a table showing the performance of a method of performing deep reinforcement learning according to an embodiment of the present disclosure, FIG. 8 is a graph showing the performance of a method of performing deep reinforcement learning according to an embodiment of the present disclosure, and FIG. 9 is an exemplary diagram showing a method of evaluating the independence between individual Q-functions according to an embodiment of the present disclosure.

Referring to FIG. 7, there are shown the results of evaluating the deep reinforcement learning algorithm based on the Q-function ensemble, to which the regularization loss function proposed in the present disclosure is applied, in an offline reinforcement learning environment. As a result of the evaluation, high performance was achieved by estimating a correct Q value while suppressing an overestimation phenomenon.

Referring to FIG. 8, there is shown a graph depicting the extent to which each of individual Q-functions departs from a semicircular distribution n a corresponding offline reinforcement learning situation. In FIG. 8, the black dotted line indicates the Wigner's semicircle distribution, the blue bar is a spike histogram based on the SAC-Min method, the orange bar is a spike histogram based on the EDAC method, and the green bar is a spike histogram based on the method according to the present disclosure. For the sake of convenience, there are shown only eigenvalues that fall outside the Wigner's semicircle distribution. According to the present disclosure, the independence of the corresponding Q-function may be evaluated using the ratio outside the semicircle indicated by the black dotted line.

Referring to FIG. 9, the graphs located on the upper left side and the lower left side, respectively, show data in the complex plane. Each of the blue dots in the complex plane shows data. The graphs located on the upper right side and the lower right side, respectively, show eigenvalues. In this case, the red solid line indicates the Wigner's semicircle distribution. Furthermore, the blue solid line indicates kernel density estimates.

In the graphs located on the upper side, it can be seen that the perturbation power ψ=0 and the eigenvalue distribution follows the Wigner's semicircle law. In the graphs located on the lower side, the perturbation force ψ=1e-05, and the eigenvalue distribution approximately follows the semicircular law except for the largest eigenvalues, which may be interpreted as spikes. Accordingly, it is found that the deep reinforcement learning algorithm proposed according to the present disclosure works desirably in both data and spectral domains.

According to the present disclosure, a reduction in performance attributable to overestimation bias may be decreased, and the degree of independence between individual Q-functions constituting a Q-function ensemble may be adjusted. Depending on the characteristics of a target task, the degree of independence of the Q-function ensemble required for learning may be determined.

Furthermore, according to the present disclosure, the eigenvalues of the Q-function ensemble may be used as an index for evaluating the degree of independence between Q-functions.

The various embodiments of the present disclosure described above may be combined with one or more additional embodiments, and may be changed within the scope understandable to those skilled in the art in light of the above detailed description. The embodiments of the present disclosure should be understood as illustrative but not restrictive in all respects. For example, individual components described as unitary may be implemented in a distributed manner, and similarly, components described as distributed may also be implemented in a combined form. Accordingly, all changes or modifications derived from the meanings and scopes of the claims of the present disclosure and their equivalents should be construed as being included in the scope of the present disclosure.

What is claimed is:

1. A method of performing deep reinforcement learning based on a Q-function ensemble, the method being performed by a computing device including at least one processor, the method comprising:
generating a symmetric matrix based on individual values respectively output from a plurality of individual Q-function models constituting a Q-function ensemble;
comparing a distribution of eigenvalues of the symmetric matrix with a reference distribution;
defining a regularization loss function based on results of the comparison; and
training the plurality of individual Q-function models based on the defined regularization loss function.

2. The method of claim 1, wherein generating the symmetric matrix comprises generating the symmetric matrix by shuffling an order of the individual values and then filling elements of an upper triangular region of the symmetric matrix with the individual values.

3. The method of claim 2, wherein a size of the symmetric matrix is determined to be a maximum size required to fill the elements of the triangular area with the individual values.

4. The method of claim 1, wherein defining the regularization loss function comprises:
calculating a pulse train probability distribution based on the eigenvalues of the symmetric matrix; and
defining the regularization loss function based on the pulse train probability distribution and the reference distribution.

5. The method of claim 4, wherein the reference distribution is a soft Wigner's semicircle distribution.

6. The method of claim 5, wherein the regularization loss function is represented by the following equation:
$${L}_{spqr} = β \frac{1}{\vert B \vert} {\sum }_{i} {\sum }_{j} {p}_{esd} ( {λ}_{i} ) log \frac{{p}_{esd} ( {λ}_{i} )}{{p}_{wigner} ( {λ}_{j} )}$$
where:
L_{spqr} is the regularization loss function;
β is a coefficient of the regularization loss function;
p_{esd}(λᵢ) is the pulse train probability distribution;
p_{wigner}(λⱼ) is the soft Wigner's semicircle distribution; and

|B| is a size of a batch sampled in a buffer.

7. The method of claim 6, wherein training the plurality of individual Q-function models comprises determining a degree of independence between the plurality of individual Q-function models by adjusting the coefficient of the regularization loss function.

8. The method of claim 7, wherein, as the coefficient of the regularization loss function increases, the degree of independence between the plurality of individual Q-function models also increases.

9. A computer program stored in a computer-readable storage medium, the computer program performing operations of performing deep reinforcement learning based on a Q-function ensemble when executed on at least one processor,
wherein the operations comprise operations of:
generating a symmetric matrix based on individual values respectively output from a plurality of individual Q-function models constituting a Q-function ensemble;
comparing a distribution of eigenvalues of the symmetric matrix with a reference distribution;
defining a regularization loss function based on results of the comparison; and
training the plurality of individual Q-function models based on the defined regularization loss function.

10. A computing device for performing deep reinforcement learning based on a Q-function ensemble, the computing device comprising:
a processor including at least one core; and
memory including program codes that are executable on the processor;
wherein the processor generates a symmetric matrix based on individual values respectively output from a plurality of individual Q-function models constituting a Q-function ensemble, compares a distribution of eigenvalues of the symmetric matrix with a reference distribution, defines a regularization loss function based on results of the comparison, and trains the plurality of individual Q-function models based on the defined regularization loss function.
